(19) United States
(12) Patent Application Publication
(10) Pub. No.: US 2016/0025996 A1
(43) Pub. Date: Jan. 28, 2016

(54) EYEWEAR HOLDER

(71) Applicant: William BACON, Rockledge, FL (US)

(72) Inventor: William BACON, Rockledge, FL (US)

(21) Appl. No.: 14/725,585

(22) Filed: May 29, 2015

Related U.S. Application Data
(60) Provisional application No. 62/027,917, filed on Jul. 23, 2014.

(51) Int. Cl. G02C 3/00; A45F 5/02

(52) U.S. Cl. CPC G02C 3/00; A45F 5/02

(57) ABSTRACT

An eyewear holder having a clip portion and a looped cord is provided. The clip portion includes a first arm and a second arm extending from a base. A space is formed in between the first arm and the second arm sized to retain a flap of material within. The looped cord is attached to and extending from the clip portion. The looped cord is sized to retain eyewear.

### CROSS-REFERENCE TO RELATED APPLICATION

This application claims the benefit of priority of U.S. provisional application No. 62/027,917, filed Jul. 23, 2014, the contents of which are herein incorporated by reference.

### BACKGROUND OF THE INVENTION

The present invention relates to eyewear and, more particularly, to an eyewear holder.

Eyewear consists of items and accessories worn on or over the eyes, for fashion or adornment, protection against the environment, and to improve or enhance visual acuity. Common forms of eyewear include glasses (also called eyeglasses or spectacles), sunglasses, and contact lenses. Eyewear can also include more utilitarian forms of eye protection, such as goggles. Currently, to retain eyewear to ones person without wearing the eyewear, a strap is needed. However, straps do not look professional and are typically inappropriate in a professional setting.

As can be seen, there is a need for an improved eyewear retainer for a professional setting.

### SUMMARY OF THE INVENTION

In one aspect of the present invention, an eyewear holder comprises: a clip portion comprising a first arm and a second arm extending from a base, and forming a space in between the first arm and the second arm sized to retain a flap of material within; and a looped cord attached to and extending from the clip portion, wherein the looped cord is sized to retain an arm of an eyewear within.

In another aspect of the present invention, a method of retaining an eyewear to a clothing article comprises: providing an eyewear holder comprising: a clip portion comprising a first arm and a second arm extending from a base, and forming a space in between; and a looped cord attached to and extending from the clip portion; securing the clip portion to a clothing article so that a flap of material of the clothing article is disposed in between the first arm and the second arm; and inserting an arm of the eyewear into the looped cord, thereby securing the eyewear to the clothing article.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a perspective view of an embodiment of the present invention in use without a pocket;

FIG. 3 is a perspective view of an embodiment of the present invention;

FIG. 4 is a side view of an embodiment of the present invention;

FIG. 5 is a front view of an embodiment of the present invention;

FIG. 6 is a top view of an embodiment of the present invention;

FIG. 7 is a section detail view of an embodiment of the present invention; and

FIG. 8 is a perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an eyewear holder. The present invention stops eyewear from falling off clothes without the use of a neck strap. The present invention also prevents a user from losing the eyewear. The present invention clips onto clothes, looks professional, and has an adjustable swivel that secures eyewear. The present invention accommodates many different sizes of eyewear with a unique design.

The clip portion may be made of metal, plastic, or some other hard material. The clip portion slides onto a shirt pocket or collar. A hanging, adjustable, and flexible cord secures the eyewear. The present invention prevents inadvertent dropping or losing of eyewear.

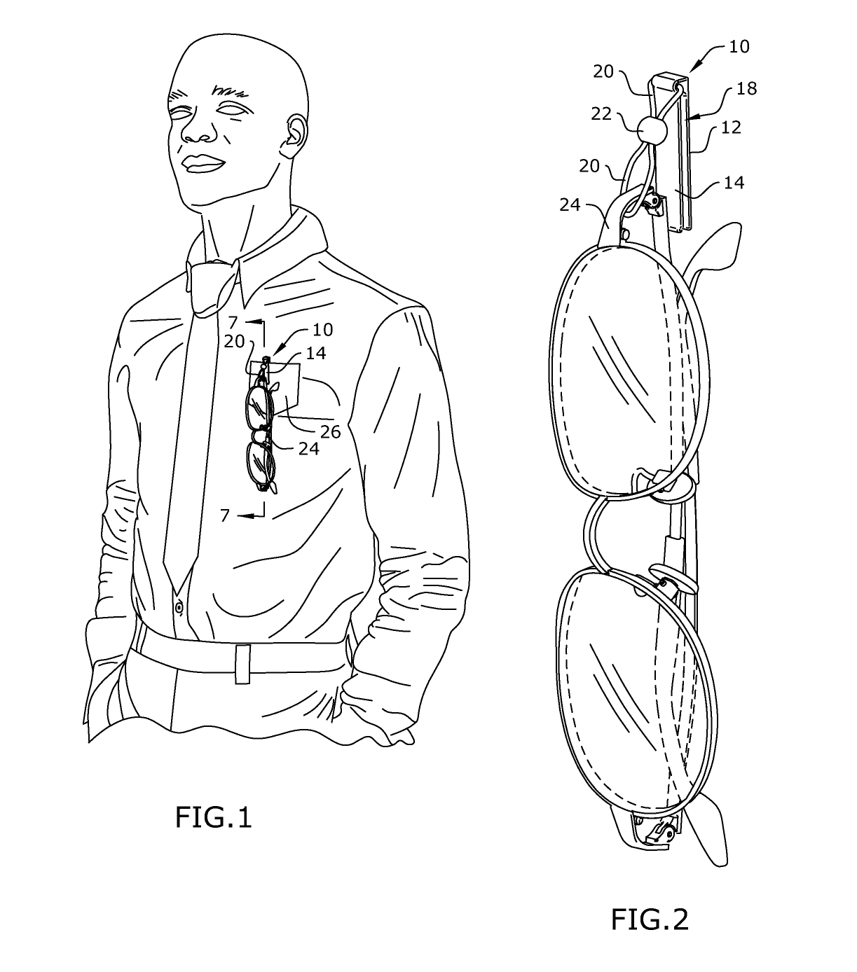

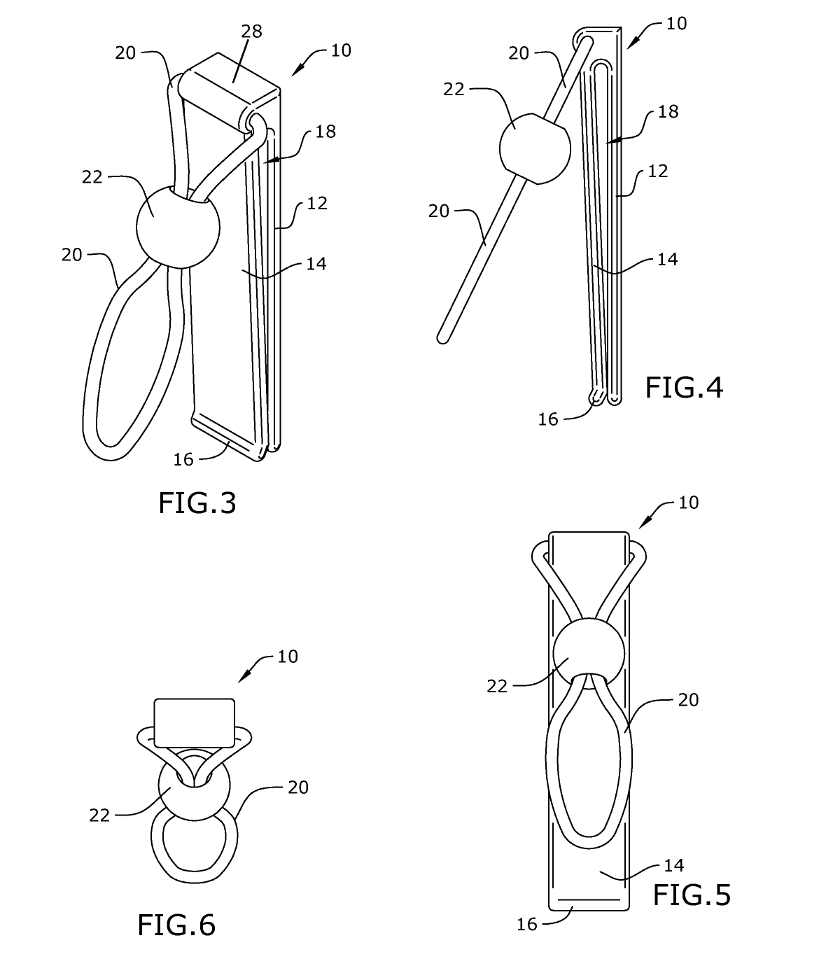

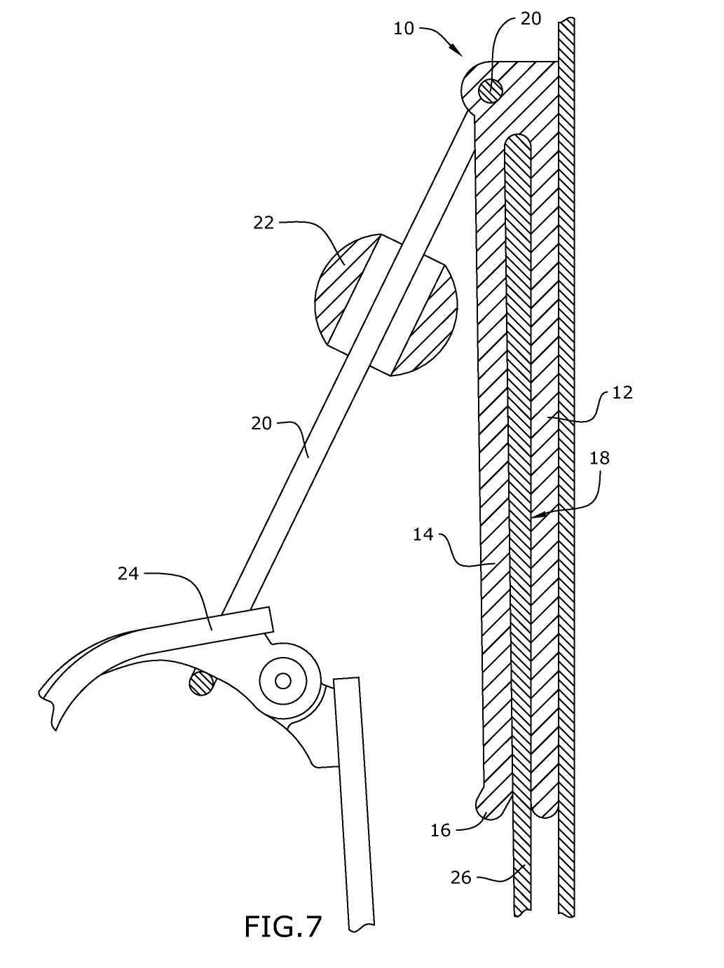

Referring to FIGS. 1 through 7, the present invention includes an eyewear holder having a clip portion 10 and a looped cord 20. The clip portion 10 includes a first arm 12 and a second arm 14 extending from a base 28. A space 18 is formed in between the first arm 12 and the second arm 14 sized to retain a flap of material within 26. The looped cord 20 is attached to and extending from the clip portion 10. The looped cord 20 is sized to retain eyewear 24.

The first arm 12 and the second arm 14 may extend in the same direction from the base 28 and may be adjacent to one another, forming the space 18 or slot in between. In certain embodiments, the first arm 12 and the second arm 14 may be spring biased towards one another to retain the flap of material 26 securely in between. In certain embodiments, a protrusion may extend from an inner surface of one of the first arm 12 and second arm 14 to further retain the flap of material 26 within. At least one of the first arm 12 and the second arm 14 may include a bent tip 16 bending away from the opposing arm. Therefore, the clip portion 12 may easily slide onto the flap of material 26.

The cord 20 of the present invention may be pivotally attached to the base 28 through a slot formed in the base 28. This allows the looped cord 20 to be more accessible to the user. In certain embodiments, a cord ball 22 may be secured around the cord 20. The cord ball 22 may slide up and down. Therefore, when the eyewear 24 is within the cord 20, the cord ball 22 may slide towards the eyewear, tightly securing the arm of the eyewear 24 within the cord 20 loop.

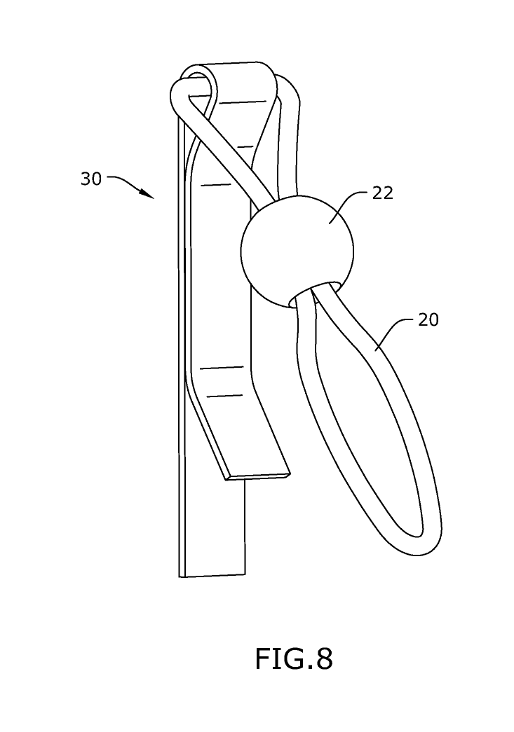

As illustrated in FIG. 8, the cord 20 may secured in between the first arm 12 and the second arm 14, near where the first arm 12 and second arm 14 join. The second arm 14 may taper towards the first arm 12, forming a narrow space in between, preventing the cord 20 from separating from the clip 30. The second arm 14 may then taper away from the first arm 12 at an end opposite an end in which the first and second arm 12, 14 meet. This allows for the clip portion 30 to easily slide onto the flat of material 26.

A method of retaining an eyewear may include the following. The eyewear holder described above is provided. The clip is releasably secured to flap of material of a clothing article, such as to a shirt pocket of the user. The flap of material is disposed in between the first arm and the second arm. An arm of the eyewear is then inserted into the looped cord, thereby securing the eyewear to the article of clothing.

It should be understood, of course, that the foregoing relates to exemplary embodiments of the invention and that modifications may be made without departing from the spirit and scope of the invention as set forth in the following claims.

What is claimed is:

1. An eyewear holder comprising:
a clip portion comprising a first arm and a second arm extending from a base, and forming a space in between the first arm and the second arm sized to retain a flap of material within; and
a looped cord attached to and extending from the clip portion, wherein the looped cord is sized to retain an arm of an eyewear within.

2. The eyewear holder of claim 1, wherein the looped cord is pivotally attached to the base.

3. The eyewear holder of claim 1, further comprising a cord ball secured around the looped cord forming a first loop and a second loop, wherein the cord ball is slidable up and down the cord altering the size of the first loop and the second loop.

4. The eyewear holder of claim 1, wherein at least one of the first arm and the second arm comprises a bent tip bending away from an opposing arm.

5. The eyewear holder of claim 1, wherein the first arm and the second arm are spring biased towards one another.

6. A method of retaining an eyewear to a clothing article comprising:
providing an eyewear holder comprising: a clip portion comprising a first arm and a second arm extending from a base, and forming a space in between; and a looped cord attached to and extending from the clip portion;
securing the clip portion to a clothing article so that a flap of material of the clothing article is disposed in between the first arm and the second arm; and
inserting an arm of the eyewear into the looped cord, thereby securing the eyewear to the clothing article.

7. The method of claim 6, wherein the looped cord is pivotally attached to the base.

8. The method of claim 6, wherein a cord ball is secured around the looped cord forming a first loop and a second loop, wherein the cord ball is slidable up and down the cord altering the size of the first loop and the second loop.

9. The method of claim 6, wherein at least one of the first arm and the second arm comprises a bent tip bending away from an opposing arm.

10. The method of claim 6, wherein the first arm and the second arm are spring biased towards one another.
